(19) United States
(12) Patent Application Publication
(10) Pub. No.: US 2009/0245066 A1
(43) Pub. Date: Oct. 1, 2009

(54) OPTICAL DATA CARRIER, AND METHOD FOR READING/RECORDING DATA THEREIN

(75) Inventors: Kanji Katsuura, Saitama-ken (JP); Ori Eitan, Jerusalem (IL); Yoshihiru Okino, Kyoto (JP); Rene Hamer, Louisville, CO (US); David Livshits, Ashdod (IL)

Correspondence Address: BROWDY AND NEIMARK, P.L.L.C.;624 NINTH STREET, NW, SUITE 300, WASHINGTON, DC, 20001-5303, US

(73) Assignee: Mempile Inc., Wilmington, DE (US)

(21) Appl. No.: 12/097,218

(22) PCT Filed: Dec. 12, 2006
(86) PCT No.: PCT/IL06/01425

§ 371 Date: Oct. 22, 2008

Related U.S. Application Data
(60) Provisional application No. 60/749,044, filed on Dec. 12, 2005.

(51) Int. Cl. G11B 7/00; G11B 7/24

(52) U.S. Cl. 369/100; 369/275.4; G9B/7

(57) ABSTRACT

An optical data carrier is presented. The data carrier comprises: at least one recording layer composed of a material having a fluorescent property variable on occurrence of multi-photon absorption resulting from an optical beam, said recording layer having a thickness for forming a plurality of recording planes therein; at least one non-recording layer formed on at least one of upper and lower surfaces of said recording layer and differing in fluorescent property from said recording layer; and at least one reference layer having a reflecting surface being an interface between the recording layer and the non-recording layer.

### FIELD OF THE INVENTION

The present invention is in the field of optical data carriers, and relates to a multi-layered optical data carrier and a method of recording/reading data therein. More particularly, the invention relates to an optical storage medium including recording and reference layers, where information is recorded on a plurality of recording planes in the recording layer on the basis of the reference layer.

### BACKGROUND OF THE INVENTION

The existing approach for optical data carriers is based on the use of reflective media. Accordingly, commercially available optical data carriers have one or two data layers, where in the latter case; the two layers are separated by a distance of about 50 microns.

Various techniques have been developed in the field of optical recording media to provide fine-patterned pit length and track pitch, to shorten the laser wavelength, and to increase the recording density by using the increased numerical aperture (NA) of an objective lens.

In recent years, for the purpose of a further increase in the recording density, recording media have been proposed that include multi-layered recording planes. When a recording light beam is focused on a position at a higher optical intensity, the optical interaction (e.g. fluorescence) property of the recording layer varies only on the focused position, resulting in data recording.

Data recording in such multi-layered optical recording medium requires precise control of the beam spot of a recording/reading beam to a desired position in the thickness direction of the medium, or the focus direction. For example, U.S. Pat. Nos. 5,408,453 and 6,538,978 disclose an optical information storage system having a multi-recording-layer record carrier and a scanner device for the carrier. The scanner produces a radiation beam which is compensated for spherical aberration for a single height of the scanning spot with the stack of layers. The height of the stack is determined by the maximum spherical aberration permissible for the system. The number of layers in the stack is determined by the minimum distance between layers, which depends on the crosstalk in the error signals due to currently unscanned layers.

Another recently developed technique for a multi-layered recording scheme employs a recording medium having a fluorescent property variable on occurrence of single- or multi-photon absorption (see for example WO 2004/032134 assigned to the assignee of the present application). In this scheme, recorded data is in the form of a three-dimensional pattern of spaced-apart data spots, such that the recording plane is not physically formed. Therefore, the conventional scheme cannot be used for precise recording in a recording plane on a desired position.

### SUMMARY OF THE INVENTION

The present invention is aimed at providing a novel optical data carrier configured to enable recording data in and reproducing (reading) data from multiple recording planes, which are located within at least one recording layer (recording medium). To this end, the data carrier of the present invention utilizes one or more reference layers presenting reflective surface(s), and one or more non-recording layers. The present invention also provides a method for recording/reproducing data in/from such a data carrier.

The reference layer may be associated with one or more recording layers. The non-recording layer has a fluorescent property different from that of the recording layer. This can be achieved by selecting the non-recording layer with a certain fluorescent property, while the recording layer, in its free of recorded data state, has no such property and the fluorescent property is created therein as a result of multi-photon interaction during the recording process. Alternatively, the recording has an initial fluorescent property (i.e. in the non-recorded state), while the non-recording layer has not.

Thus, the present invention provides a structure of an optical data carrier for recording or reproducing information in a monolithic optical recording medium, and a method of recording and reproducing in the medium. More particularly, this invention provides an optical data carrier without a need for recording planes to be determined in advance (at the time of production thereof), and in which information is recorded by changing a fluorescent property of the recording medium using multi-photon absorption. The optically recorded data may be retrieved by detecting a change in fluorescence property based on excitation caused by multi-photon absorption.

There is thus provided according to one aspect of the invention, an optical data carrier, comprising:

at least one recording layer composed of a material having a fluorescent property variable on occurrence of multi-photon absorption resulted from an optical beam, said recording layer having a thickness for forming a plurality of recording planes therein;

at least one non-recording layer formed on at least one of upper and lower surfaces of said recording layer and differing in fluorescent property from said recording layer; and

at least one reference layer having a reflecting surface being an interface between the recording layer and the non-recording layer.

In preferred embodiments of the invention, the reference layer is formed with a certain pattern (surface relief). This pattern is configured for detecting effects of focusing of a recording/reproducing beam and focusing of a reference beam independent of the recording/reproducing beam.

The reference pattern is preferably in the form of an array of spaced-apart pits. A volume (e.g. depth) of the pit is selected to maximize a servo signal used for tracking.

According to some embodiments of the invention, the array of pits includes the pits configured with a substantially rectangular cross-sectional shape and having a depth optically corresponding to a depth of (λ₂/4n+k×λ₂/2n), where λ₂ is a wavelength of the reference beam, n is a refractive index at the wavelength λ₂ of a material interfacing with said reference layer upstream thereof in a direction of propagation of the optical beam towards the reference layer, and k is an integer of 1 or more.

According to some other embodiments of the invention, the array of pits includes the pits configured with a substantially rectangular cross-sectional shape and having a depth optically corresponding to a depth of (λ₂/8n+k×λ₂/2n).

The array of pits may include at least one first pit having a width selected to be smaller than a beam spot cross-sectional dimension of the reference beam, and at least one second pit having a width selected to be equal to or larger than the beam spot cross-sectional dimension of the reference beam. The width b of the pit is preferably selected to satisfy a condition that A/2<b<A, where A is a beam spot cross-sectional dimension of the reference beam. Generally, the first pit and second pits may be of different volumes, i.e., of substantially the same depth and different widths, or vice versa. The depth of the first pit may be selected such that reflections of the reference beam from the pit bottom and from the pit top cancel each other out by interference. In some other embodiments, the array of pits may include the pits of substantially the same depth and width defining the pit volume maximizing the fluorescent response and the reflection of the reference beam.

The configuration may be such that the first pit has a depth of λ₂/4n and the second pit has a depth larger than said first pit by k×λ₂/2n. In some other embodiments, the first pit is configured with a depth of λ₂/4n, and the second pit is configured with a depth of 3λ₂/4n.

The data carrier may be configured such that the recording layer is located between two reference layers; or such that the reference layer is located between two recording layers.

According to another aspect of the invention, there is provided an optical data carrier, comprising: a recording layer composed of a material having a fluorescent property variable on occurrence of two-photon absorption; and at least two reference layers formed on both surfaces of said recording layer to form respective pre-formatted reflecting interfaces.

According to yet another aspect of the invention, there is provided an optical data carrier, comprising: at least two recording layers composed of a material having a fluorescent property variable on occurrence of multi-photon absorption; and a reference layer formed between said recording layers to form a pre-formatted reflecting interface.

According to yet a further aspect of the invention, there is provided a method for recording/reproducing data in the above-described optical data carrier, the method comprising multi-layered recording to or reproducing data from said recording layer, based on at least one of the following: detection of reflection of light from a pattern formed in the reference layer and detection of a fluorescent response from the data carrier.

The recording of data may include controlling detection of the reflection of the reference beam, while reproducing the recorded data includes controlling detection of the light response from the data carrier, and preferably also controlling detection of the reflection of the reference beam.

Considering the use of two of the reference layers in the data carrier, the recording/reproducing method may include multi-layer recording to or reproducing from said recording layer, based on at least one of the following: detection of reflection of light from a pattern formed in the reference layer and detection of a fluorescent response from the data carrier, at both surfaces of said recording layer.

According to yet another aspect of the invention, there is provided a method for recording/reproducing data in an optical data carrier, said optical data carrier including at least two recording layers composed of a material having a fluorescent property variable on occurrence of multi-photon absorption, a non-recording layer formed at either upper and lower sides of said recording layer and differing in fluorescent property from said recording layer, and a reference layer formed between said recording layers to form a pre-formatted reflecting surface, said method comprising multi-layered recording to or reproducing from said recording layers at both surfaces of said reference layer, based on at least one of the following: detection of reflection of light from a pattern formed in the reference layer and detection of a fluorescent response from the data carrier.

The recording method may include: focusing both a reference beam and a recording/reproducing beam onto a reference track on the first reference layer; while keeping a focus of the reference beam on the reference track on the first reference layer, and keeping both beams coaxial to each other, moving a focus position of said recording/reproducing beam to focus said recording/reproducing beam on a second reference layer, being an interface or a surface where the fluorescence property changes; and measuring a distance between the first and second reference layers, to perform calibration of a focusing servomechanism.

The above may be implemented by moving the focus position of the recording/reproducing beam for recording based on the calibration result of the focusing mechanism, where moving is carried out while keeping a focus of the reference beam on the reference track on the first reference layer, and keeping the positional relationship between both beams.

According to some other embodiments, the recording of data may include: focusing a reference beam on a certain reference layer and performing tracking control to keep the reference beam focused on a reference track on the reference layer; focusing a recording/reproducing beam on the same reference layer as the reference beam; and while keeping a focus of the reference beam on the reference track on the reference layer, moving a focus position of said recording/reproducing beam to record or reproduce information.

The invention also provides in its broad aspect a reading method for an optical data carrier, the method comprising: reading a reproduced signal while vibrating a focus position of a reproducing beam at a first frequency in the focus direction relative to a recording pit recorded in a recording layer for multi-layered recording; and performing focusing control of said reproducing beam relative to said recording pit based on a relation between a variation in intensity of said reproduced signal and a direction of movement of said focus position.

In yet other embodiment, the invention provides a method for data recording in an optical data carrier, comprising vibrating a focus position of a recording beam relative to a recording layer for multi-layered recording at a first frequency in the focus direction to form a recorded mark in the recording layer.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIGS. 1A and 1B illustrate two examples, respectively, of an optical system of the invention for recording/reproducing data in an optical data carrier;

FIG. 2 illustrates an example of the optical data carrier of the present invention;

FIG. 3 exemplifies a cross-sectional view (circumferential direction) and a plan view of pit-formed portions in the reference layer suitable to be used in the optical data carrier of the present invention;

FIG. 4 shows the principle of the invention for controlling the focusing the recording/reproducing beam on the reference layer;

FIGS. 5 to 13 show several more examples of the pit shape formed in the reference layer suitable to be used in the optical data carrier of the present invention;

FIG. 14 illustrates an example of an optical data carrier of the present invention;

FIG. 15 exemplifies a flowchart of a method of the invention for controlling the number of recording planes formed in one recording layer and the interval therebetween;

FIG. 16 illustrates a recording method for recording in two recording layers 1 located above and below a reference layer 2;

FIG. 17 exemplifies a reproducing method of the present invention;

FIG. 18 shows a relation between the focused position of the recording/reproducing beam (when the position of the recording plane to be read is determined zero) and the amount of fluorescence received at the detector;

FIG. 19 illustrates a recording method of the present invention;

FIG. 20 illustrates a wobbling executed in tracking control, according to the invention; and

FIGS. 21A-21D and 22 show yet another example of a wobbling technique used in the present invention.

### DETAILED DESCRIPTION OF EXEMPLARY EMBODIMENTS

Some embodiments of the present invention will now be exemplified with reference to the accompanying drawings.

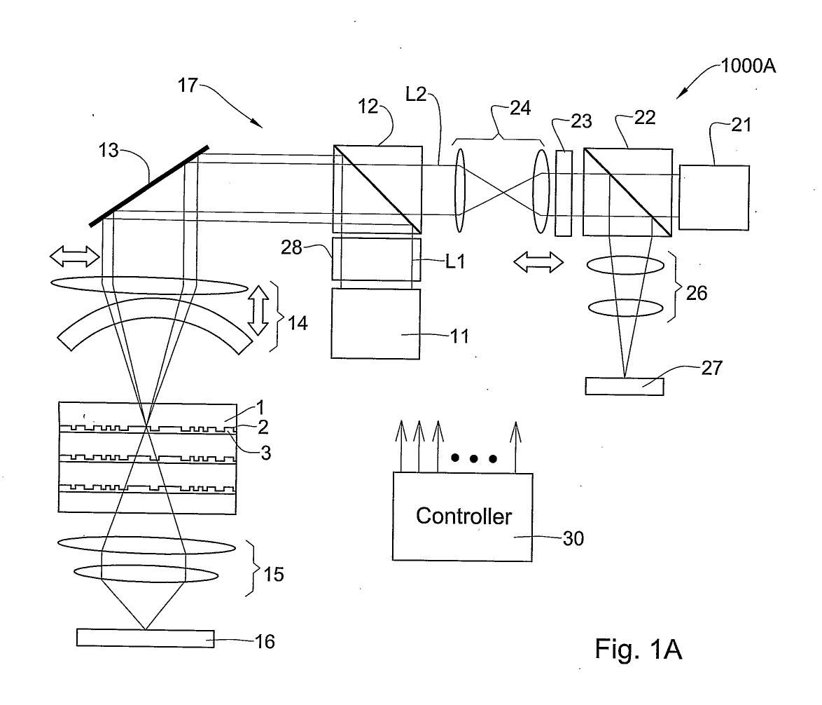

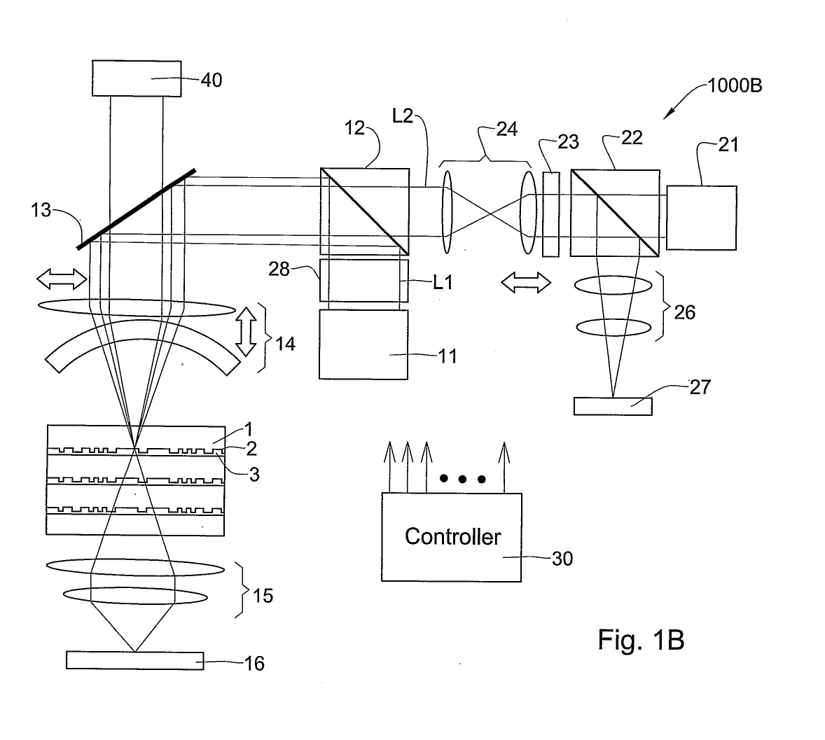

FIG. 1A shows an example of the configuration of an optical system, generally designated 1000A, for recording/reading data in an optical recording medium 10. The optical recording medium 10 is for example a non-linear medium in which data can be recorded/read on occurrence of multi-photon (e.g. two-photon) absorption. Such a recording medium is disclosed in various patent applications and patents assigned to the assignee of the present application. For example Patent Convention Treaty (PCT) publication WO 01/73779 discloses a non-linear three dimensional memory for storing information in a volume comprising an active medium. The active medium is capable of changing from a first to a second isomeric form as a response to radiation of a light beam having energy substantially equal to first threshold energy. The concentration ratio between a first and a second isomeric form in any given volume portion represents a data unit. This PCT publication discloses an optical storage medium that comprises diarylalkene derivatives, triene derivatives, polyene derivatives or a mixture thereof. An optical storage medium with photoactive groups has been disclosed in various PCT publications assigned to the assignee of the present application, for example WO 2006/0117791, WO 2006/075326, WO 2001/073779, WO 2006/075328, WO 2003/070689, WO 2006/111973, WO 2006/075327, WO 2006/075329.

The data carrier 10 includes at least one recording layer 1, at least one reference layer 2, and at least one adhesion layer 3. In the present example, multiple recording layers are shown being arranged such that the recording layer 1 (except for the uppermost one) is located in between the two locally adjacent reference layers 2. Also, in the present example, each recording layer has its associated reference layer. It should however be noted that, generally, one reference layer may serve for more than one recording layer. The reference layer 2 is a reflective layer. The recording layer 1 is configured to enable creation therein multiple recording planes, as will be described further below.

The system 1000A includes a light source system formed by a first light (laser) source unit 11 operative to emit a recording/reading light beam L₁, and a second reference light (laser) source 21 operative to emit a reference light beam L₂. The system 1000A further includes a light detection system, which in the present example is formed by two detection units 16 and 27; and a light directing system, generally at 17, configured for directing and focusing the recording/reading beam onto a desired location in the medium 10 and for directing light returned from the medium response towards the detection system. The detection unit 16 is associated with its collection optics 15 (formed by two lenses in the present example) and serves for detecting the light response of the medium to the reading beam. The detection unit 27 is also associated with its imaging optics 26 (e.g. two lenses) and serves for detecting reflection of the reference beam from the reference layer 2. Also provided in the system 1000A is a control unit 30, connectable to the light source system and the detection system (via wires or wireless signal transmission as the case may be), and operating to adjust the operational mode of the light source system and receive and analyze the output of the detection system.

The recording/reproducing laser source unit 11 includes a light source capable of emitting light of a wavelength range suitable to cause the multi-photon interaction for the data recording/reading in the data carrier 10, for example a wavelength λ₁ of about 671 nm. The laser source 11 is configured for controllably varying the output thereof such that it selectively emits a light pattern suitable for recording and reading processes, for example light of an average output of 1 W and a pulse width of about tens of pico-seconds for recording and light of an average output of 1.0 W and a pulse width of about tens of pico-seconds for reading/reproducing.

The reference laser source unit 21 includes a light source operable for tracking servo and focusing servo of the data carrier 10. This light source emits the reference light beam (laser beam) L₂ of a suitable wavelength range (which may be different or not from that of the recording/reading beam), for example having a wavelength 2 of about 780 nm. The reference light source unit preferably also includes a polarized beam splitter 22 and a polarization rotator (e.g. ¼-wavelength plate) 23 in the optical path of the emitted reference beam L₂.

The light directing and focusing system 17 includes a beam splitter/combiner 12 in the optical path of the recording/reading and reference beams L₁ and L₂; a focusing optics 24 (formed by one or more lenses for example—two such lenses being shown in the present example) at the output of the reference light system configured for focusing the reference light beam L₂ (of the appropriate polarization) onto the beam splitter/combiner 12; and a focusing/collecting optics 14 (formed by one or more lenses—two such lenses being shown in the present example) for focusing the incident light (optical beam) onto a desired location in the medium and collecting light returned from the medium. Also preferably provided in the light directing and focusing system 17 is a controllably movable reflector unit 28 (e.g. mirror driven for movement by a piezo-element) accommodated in the optical path of the recording/reading beam L₁, for the purpose that will be described further below. Further provided is a mirror 13 accommodated in the optical path of the incident light propagating from the beam splitter/combiner 12 to direct it to the focusing optics 28 and to direct light returned from the medium and collected by optics 28 to direct it to the beam splitter/combiner 12.

The system 1000A operates as follows: The reference beam L₂ is directed towards the medium as described above, i.e. its polarization is preferably appropriately adjusted; and then it is focused by optics 24 onto the beam combiner 12, reflected by the mirror 13, and further focusing by the optics 14 onto a desired the reference layer 2. This reference light is reflected from the reference layer 2 and returns back through the same optical path, i.e. optics 14, mirror 13, beam splitter/combiner 12, optics 24 and polarized beam splitter 22. The latter reflects the reference beam L₂ to pass through the imaging lens 26 to the detector 27. Based on the output signal from the detector 27 (being analyzed by the controller 30), the focusing optical systems 14, 24 are controlled (by the same controller 30 or another control unit as the case may be) such that the focused position of the reference beam L₂ is always substantially coincident with the reference layer 2. Considering for example a four-part split detector is used in the detection unit 27, tracking control can be executed using a well-known push-pull method.

The recording/reproducing beam L₁ in turn passes the beam splitter/combiner 12, is reflected by the mirror 13, and focused by the focusing optical system 14 on the same reference layer 2 in the medium 10 as the reference beam L₂ focuses on. Specifically, the recording/reproducing beam L₁ is focused on the same reference layer 2 as the reference beam L₂, by operating the focusing optical system 24 to perform wobbling along the optical axis direction, as will be described below.

Next, by an operation of the piezo mirror 28, the recording/reproducing beam L₁ is focused on the same track as the reference beam L₂ is focused on, or a certain track related to it. In this situation, the reference beam L₂ is always focused on the reference layer 2 by an operation of the focusing optical system 14 controlled by the controller 30 as a servomechanism. Subsequently, by driving the focusing optical system 24, a focus position of the recording/reproducing beam L₁ in the data carrier thickness direction is moved by a certain distance. By controlling the intensity of the recording/reproducing beam L₁ to be of the intensity suitable for recording, the fluorescent property (constituting the medium excitation by multi-photon interaction) of the recording layer 1 varies on the focused position, resulting in execution of data recording. During the data reading process, when the recording/reproducing beam L₁ is focused on the recorded position, a fluorescent light (constituting the light response of the medium) is emitted in accordance with the condition on the recorded position. The fluorescent light is then guided through a lens 15 to the detector 16, and, based on the detected signal, the recorded data can be reproduced. To form the beam spot of the recording/reproducing beam L₁ precisely on a desired recording plane, the optical system 14 forming the projection optical path of said beam is configured as a spherical aberration-corrected optical system. In addition, the focusing optical system 14 is designed such as not to cause any spherical aberration higher than a predetermined tolerance. As for the reference beam L₂, small spherical aberration is generally allowed.

Reference is made to FIG. 1B showing another example of an optical system, generally designated 1000B, for recording/reading data in an optical recording medium 10. To facilitate understanding, the same reference numerals are used for identifying components that are common in the examples of the invention. As can be seen, the system 1000B is configured generally similar to the above-described system 1000A, distinguishing therefrom in that here the light source system also includes a separate heating beam laser source 40 that emits a heating light beam L₃, which, during the recording process, is to be directed to the recording position together and simultaneously with the recording/reproducing beam L₁. To this end, in the present example, mirror 13 is a wavelength-selective element (dichroic mirror), which reflects the recording/reproducing and reference light beams L₁ and L₂ and transmits the heating light beam L₃ to allow its focusing by the optics 14 onto a desired plane in the medium 10. The heating beam L₃ is focused by the focusing optical system 14 almost on the same position as the recording/reproducing beam L₁. The tracking servo and focusing servo controls are executed by the controller 30 based on the detected signals from the detectors 16, 27. This will be described more specifically further below.

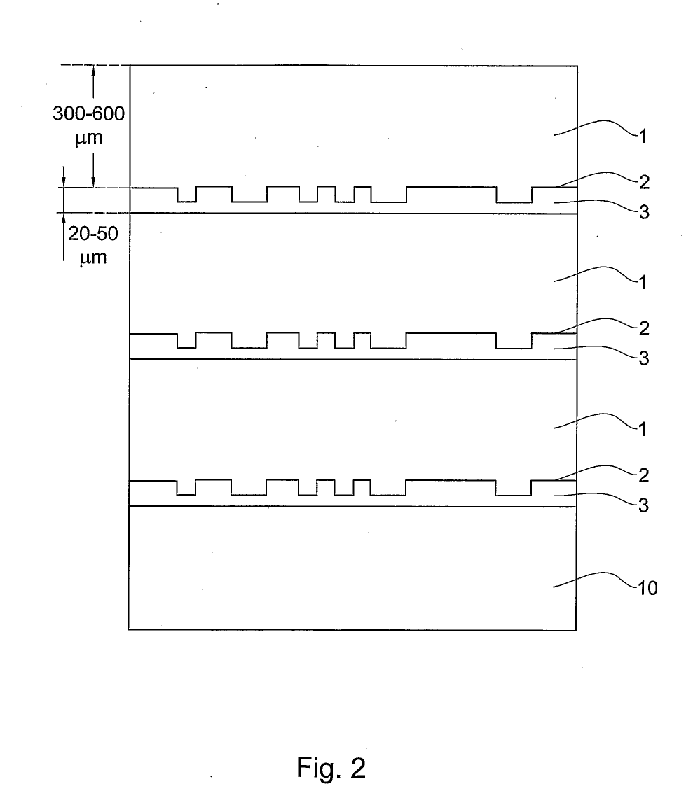

Reference is made to FIG. 2 showing schematically an example of the optical data carrier 10 according to the embodiment of the present invention. The data carrier 10 includes recording layers 1, reference layers 2 and adhesive layers 3 stacked sequentially and repeatedly in a direction from the upper surface of the carrier (i.e. the surface by which it is to be exposed to the incident light). The recording layer 1 serves to record data therein and reproduce the written data therefrom. The reference layer 2 serves as a reference surface to focus the recording/reproducing beam on a desired position in the recording layer 1. As will be described further below, focusing of the recording/reproducing beam is controlled by detection of at least one of the following: reflection of the reference beam from the reference layer 2 and fluorescent response from the recording layer. More specifically, during recording, focusing of the recording/reproducing beam is controlled by detection of reflection of the reference beam, and during reading, focusing of the recording/reproducing beam is controlled by detection of fluorescent response from the recording layer and preferably also reflection of the reference beam. It should be noted that when speaking about detection of the fluorescent response for the purposes of controlling the focusing, this fluorescent response may be from the recording layer or from the non-recording layer in accordance with the selected change in fluorescent property of these layers. The adhesive layer 3 serves to adhere a plurality of recording layers 1 (together with their associated reference layers 2) to each other. It should be noted that in case a single reference layer is used (being formable with a plurality of recording planes), layer 3 serves as a substrate carrying the entire structure. This layer 3 may be a non-recordable layer (i.e. which is not intended to recording/reading data therein); or may also be a recording layer with a material composition similar or different from the main recording layers (plates) 1. In this specific but not limiting example, the recording layers 1, the reference layers 2 and the adhesive layer 3 are formed repeatedly, and another recording layer 1 is formed as the lowermost layer.

It should be noted, although not specifically shown, that the data carrier configuration is preferably formed with protective layers at its outer surfaces. This can be implemented by applying suitable transparent films over the upper surface of the uppermost recording layer 1 and the lower surface of the lowermost recording layer 1. Preferably, however, the protective layers can be formed with the same recording medium, by locating the uppermost and lowermost recording layers 1 at a distance (depth) from the respective upper and lower surfaces of the medium, where this depth is selected so that ambient light passing therethrough will be attenuated to a level in which it will not cause any harmful interaction.

The recording layer 1 is composed of a material having a fluorescent property variable on occurrence of multi-photon (two-photon) absorption. Such material may be a copolymer of 4-methoxy-4′-(8-acryloxyoctyloxy)-trans-α,β-dicyanostylbene (hereinafter referred to as a compound trans-A) and methyl methacrylate, as well as other materials described in the international publication of WO 03/070689 assigned to the assignee of the present application. Plural recording planes, for example, in tens of layers, can be formed in one recording layer 1. The recording layer 1 itself is a bulk substrate, monolithic with respect to the wavelength resolution as discussed in WO 06/075327 assigned to the assignee of the present application. Such a bulk substrate may be composed of a single material having a fluorescent property variable on occurrence of two-photon absorption, and may be a material having a fluorescent property variable on occurrence of two-photon absorption and uniformly dissolved or substantially uniformly dispersed in a substrate material. The recording layer need not contain any dedicated positional information in either the radial direction (tracking direction) or the data carrier thickness direction (focus direction). Positional information is given from the reference layer 2, as will be described further below, such that data can be recorded with the aid of the tracking direction position signal in the reference layer 2 and the data for setting the focus direction distance from the reference layer 2 to the recorded layer.

The recording layer 1 is given a thickness in accordance with the number of the recording planes for multi-layered recording. The number of the recording planes is determined from the non-linear media response, the optics (e.g. interrogation wavelength or numerical aperture), the accuracy of the recording/reproducing optical system and the dimensional precision of the data carrier itself.

As shown in FIG. 2, in order to form 30 recording planes above and 24 recording planes below the reference layer 2 (as will be described more specifically further below), the thickness of one recording layer 1 can be about 300-600 μm.

As indicated above, the reference layer 2 has a reflecting surface. This can be formed by a film with low reflectance (about 2-50%) evaporated on a pitted/protruded surface, which is pre-formatted in the lower surface of each recording layer 1 using the well-known stamper. Alternatively, the reflecting surface may be formed by a difference in refractive index between the recording layer 1 and the adhesive layer 3.

The reflecting surface 2 includes pits having certain widths or depths (as will be described below). The pits are used in calibration of the reference beam (L₂ in FIGS. 1A-1B) and the recording/reproducing beam L₁ in the tracking direction and the focus direction. Therefore, the pits are formed to detect focusing of the recording/reproducing beam L₁ on the reference layer 2 and focusing of the reference beam L₂ on the reference layer 2 as will be described in more details further below.

The adhesive layer 3 is highly transmitting for the wavelength(s) of the reference beam L₂ and the recording/reproducing beam L₁ while its material composition differs in fluorescent property from the material of the recording layer 1 used in the data carrier. For example, as the material of the non-recording layer, a polycarbonate, a methyl methacrylate copolymer (PMMA), a photo-cured acrylic photo-polymerizing adhesive may be employed. These materials have different fluorescent properties, being a necessary and sufficient condition. Accordingly, the adhesive layer 3 itself may be composed of a material having no fluorescent property at all or a material differing in fluorescence emission efficiency or emission wavelength from the recording layer 1. Alternatively, the recording layer 1 itself may be composed of a material having weak fluorescent property normally (before writing) while the adhesive layer 3 may be composed of a material having a strong fluorescent property. A copolymer of methyl methacrylate and the 4-methoxy-4′-(8-acryloxyoctyloxy)-cis-α,β-dicyanostylbene (hereinafter referred to as a compound cis-A) may be used in the recording layer 1, while a copolymer of the above compound trans-A and acrylic photo-curing adhesive may be used in the adhesive layer 3. This provides for different fluorescent properties for layers 1 and 3.

According to yet other option, both the recording layer 1 and the adhesive layer 3 may be produced of the isometric copolymer of the same material, such as the copolymer of the compound A, with one of these layers being made mainly of the compound trans A (trans-rich) and the other being made mainly of the compound cis-A (cis-rich). This also satisfies the requirement for different fluorescent properties in layers 1 and 3. The non-recording layer may be formed of air. As the air layer has no fluorescent property, it is possible to achieve the same effect as the above configuration has.

As for a pattern formed in the reference layer, in this specific embodiment, it includes a pit-shaped one, and a groove-shaped one. In this specification, the terms “pit” and “groove” are collectively referred to as a “pit”.

The pit pattern is used for tracking servo control. The present invention provides shapes of pits for efficiently picking up both a servo signal and a written (recorded) signal.

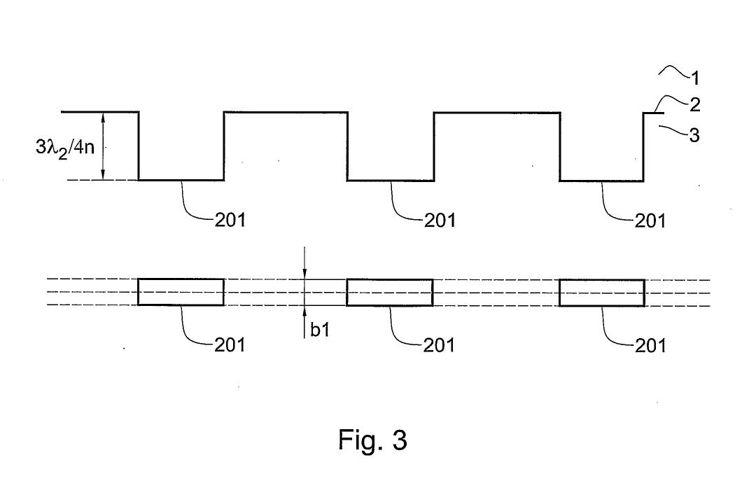

A method of controlling by reading a written signal from a pit is explained hereinbelow. An example of the pit shape formed in the reference layer 2 is described with reference to FIG. 3, which shows a cross-sectional view (circumferential direction) and a plan view of pit-formed portions in the reference layer 2. In this specific but not limiting example, pits 201 in the reference layer 2 are configured to generate a servo error signal associated with both the recording/reproducing beam L₁ and the reference beam L₂. When a sectional shape of the pit 201 is assumed as an accurate rectangular shape, it is formed to have a depth D optically corresponding to a depth of D=λ₂/4n+k×λ₂/2n, where k is an integer of 1 or more, and n denotes a refractive index at the wavelength λ₂ of the material interfacing with the reference layer 2 upstream thereof in a direction of the incident light propagation towards the reference layer, for example, for k=1, D=3λ₂/4n. This depth makes it possible to detect both the recording/reproducing beam L₁ and the reference beam L₂. In practical, the sectional shape of the pit 201 may not be of a rectangular shape but of other shapes such as a trapezoid shape and a barreled shape. In such a case, a rectangular shape with a depth of λ₂/4n+k×λ₂/2n is first assumed, and computer simulation is then applied to compute a depth of another shape from such a pit pattern that can obtain substantially the same reflected light pattern as the rectangular shape pit pattern does.

As the pit 201 has the depth D=λ₂/4n+k×λ₂/2n, reflected light components of the reference beam L₂ from peak and valley of the pit 201 have a phase difference equal to half a wavelength regardless of the value of k and thus provide inverted phases. Therefore, both light components cancel each other by interference. Accordingly, a light component impinging on the pit 201 and a light component impinging on a portion other than the pit 201 have a large difference in optical intensity. Thus, tracking and focusing control of the reference beam L₂ to the pit 201 can be performed precisely.

On the other hand, setting the value of k to 1 or more enhances the variation in the amount of fluorescent light between regions of the medium interacting and not with the recording/reproducing beam L₁ on the pit 201. Thus, tracking and focusing control of the recording/reproducing beam L₁ can also be performed precisely. The pit depth D is not required to precisely satisfy the condition that D=λ₂/4n+k×λ₂/2n, but rather is allowed to fluctuate therefrom at about 30% on the basis of λ₂/4n.

The width b₁ of the pit 201 is determined within a range A/2<b1<A where A is the cross-sectional dimension (e.g. diameter) of the beam spot at the beam waist position of the reference beam L₂. With such a width, focusing of the reflection of the reference beam L₂ can be detected (e.g., by detector 27 in FIGS. 1A and 1B). In addition, it is possible to more precisely execute focusing detection based on the variation in the amount of fluorescent light resulting from the medium interaction with the recording/reproducing beam L₁.

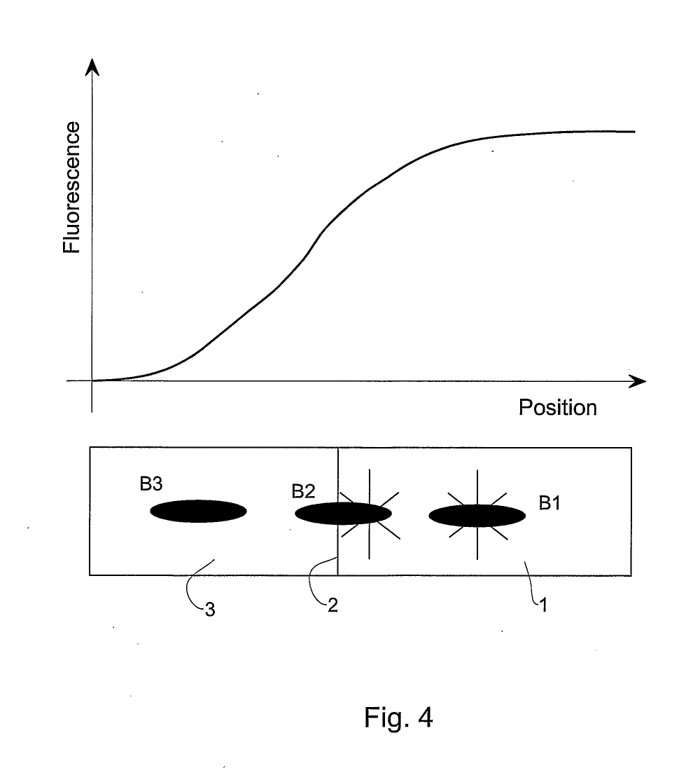

The principle of detecting the recording/reproducing beam L₁ focused on the reference layer 2 will now be described with reference to FIG. 4. As described above, the recording layer 1 and the adhesive layer 3 have different fluorescent properties. It is assumed herein that the recording layer 1 has a fluorescent property (e.g. is excitable by two-photon interaction to fluoresce) and the adhesive layer 3 has no fluorescent property. In this case, as shown in FIG. 4, when the reading beam spot is located entirely in the recording layer 1 (position B1), the amount of fluorescence reaches its maximum. When the beam spot is located half in the recording layer 1 (position B2), the amount of fluorescence exhibits half that of position B1, or a middle value. When the beam spot is located entirely in the adhesive layer 3 (position B3), the amount of fluorescence reaches its minimum. If the focused position of the recording/reproducing beam L₁ is controlled to a position with the middle amount of fluorescence, calibration between the recording/reading and reference beams L₁ and L₂ can be executed.

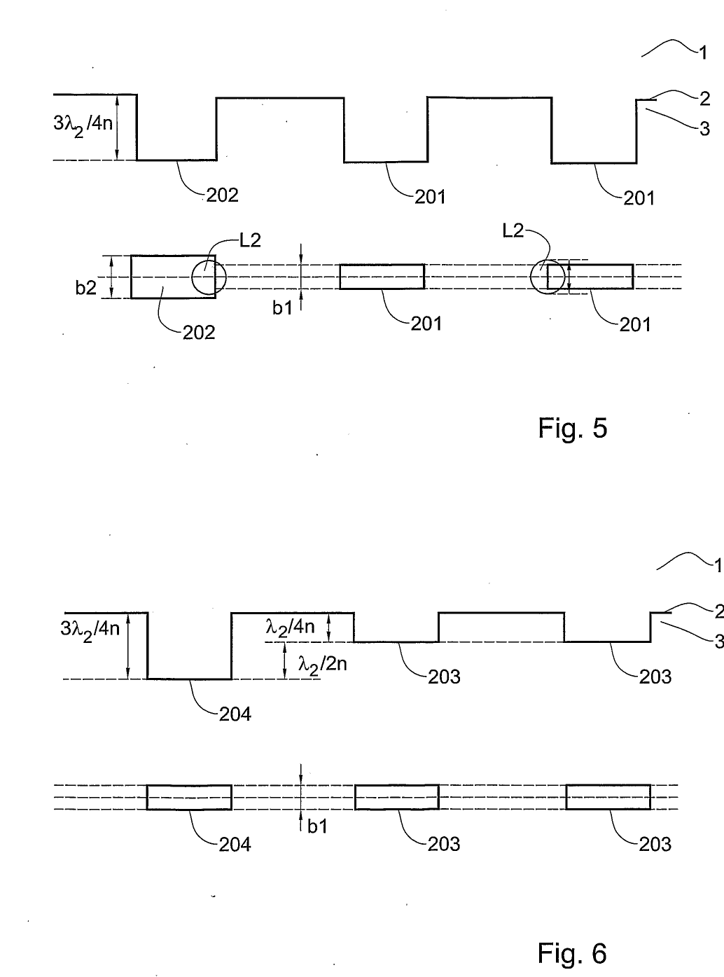

Referring to FIG. 5 there is shown another example of the pit shape formed in the reference layer 2. In this example, two types of pits are formed in the reference layer 2: a pit 201 intended for use in detection of the reference beam L₂ as described above with reference to the example of FIG. 3; and a pit 202 for use in detection of the recording/reproducing beam L₁.

Assuming a cross-sectional shape of the pit 201 as an accurate rectangular shape like that of the example of FIG. 3, the pit depth D and width b1 are respectively D=λ₂/4n+k×λ₂/2n and A/2<b1<A. The pit 202 has a pit depth D similar to that of the pit 201 but has a width b2 equal to or larger than the beam spot diameter A, for example, b2>A. As a result, reflections of the reference beam L₂ from the medium location within the pit 202 and the medium location outside the pit 202 are of substantially the same optical intensity. Therefore, the pit 202 cannot serve for detection of the reference beam L₂. On the contrary, when the recording/reproducing beam L₁ impinges on the pit 202, the amount of fluorescence difference caused therefrom can be increased by the extent corresponding to the extended width. Accordingly, the use of such a pit 202 enables the precision of focusing control of the recording/reproducing beam L₁ to be enhanced.

FIG. 6 shows yet another example of the pit shape formed in the reference layer 2. In this example, the reference layer 2 includes pits 203 of an accurate rectangular cross-sectional shape with a depth of λ₂/4n (where n denotes a refractive index at the wavelength λ2 of the material interfacing with the reference layer 2 upstream thereof), and pits 204 with a depth of λ₂/4n+k×λ₂/2n (where k is an integer of 1 or more). In other words, the pits 203 and 204 have different pit depths and substantially the same width b1. The pits 203, 204 generate a similar servo error signal associated with the reference beam L₂. The pit 204 has a depth D1 larger than depth D2 of the pit 203 by k×λ₂/2n (D1=D2×k×λ₂/2n), to generate a servo error signal associated with the recording/reproducing beam L₁.

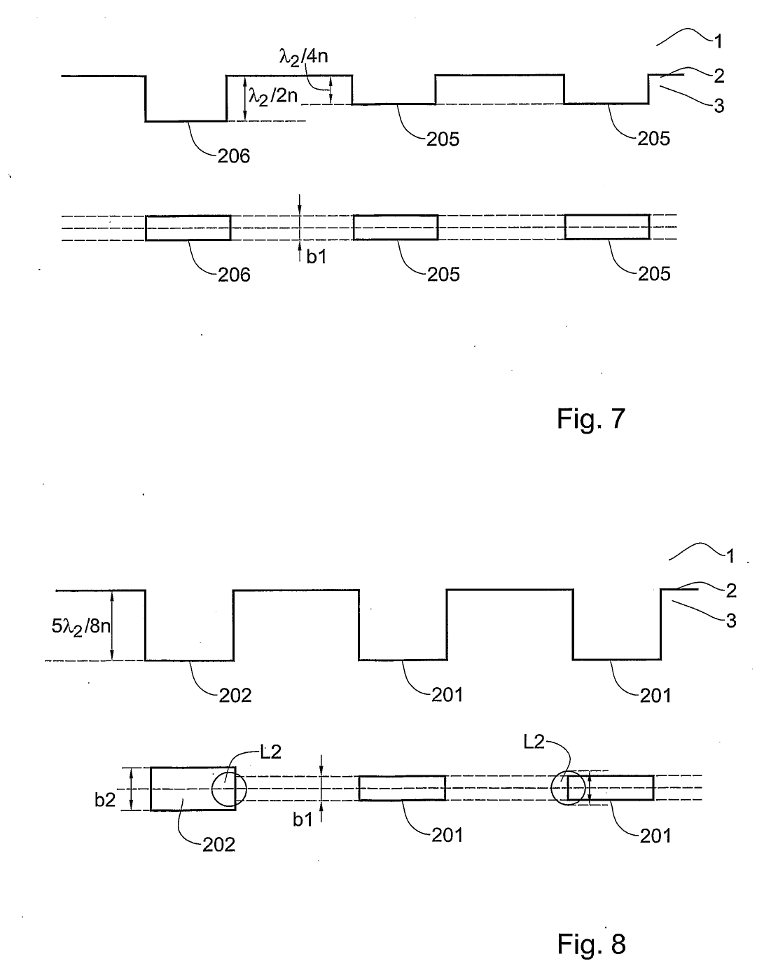

Yet other example of the pit shape suitable to be formed in the reference layer 2 is described with reference to FIG. 7. Here, the reference layer 2 includes a pit 205 configured for detection of the reference beam L₂ and a pit 206 for detection of the recording/reproducing beam L₁. The pit 205 has a depth of λ₂/4n, when the cross-sectional shape thereof is assumed as an accurate rectangular shape like the pit 203 of FIG. 6. This maximizes the difference in intensity between the reference beam reflections on a focusing location within the pit 205 and a location outside the pit 205. The pit 206 has a larger depth of λ₂/2n. Therefore, even when the reference beam L₂ impinges on the pit 206, the reflected light therefrom is similar to that from the position outside the pit 206 in relation to the difference between the optical path lengths. Thus, the pit 206 exerts no influence on detection of focusing the reference beam L₂. To the contrary, with regard to the recording/reproducing beam L₁, a difference between the depths of pits 205 and 206 provides a difference in the amount of fluorescence associated with the recording/reproducing beam L₁ interaction with the respective locations in the reference layer. Accordingly, the difference in the amount of fluorescence can be employed to detect the recording/reproducing beam L₁ focused on the reference layer 2.

The following is the description of how a pit shape maximizes a servo signal when servo control is performed by detecting a tracking error signal from the pattern in the reference layer 2.

In this case, assuming that the pit has a rectangular cross-sectional shape and that servo control using a push pull method is employed, a suitable depth of the pit that maximizes the servo signal is λ₂/8n, where λ₂ is a wavelength of the reference beam L₂, and n is the refractive index at the wavelength λ₂ of the material interfacing with the reference layer 2 upstream thereof.

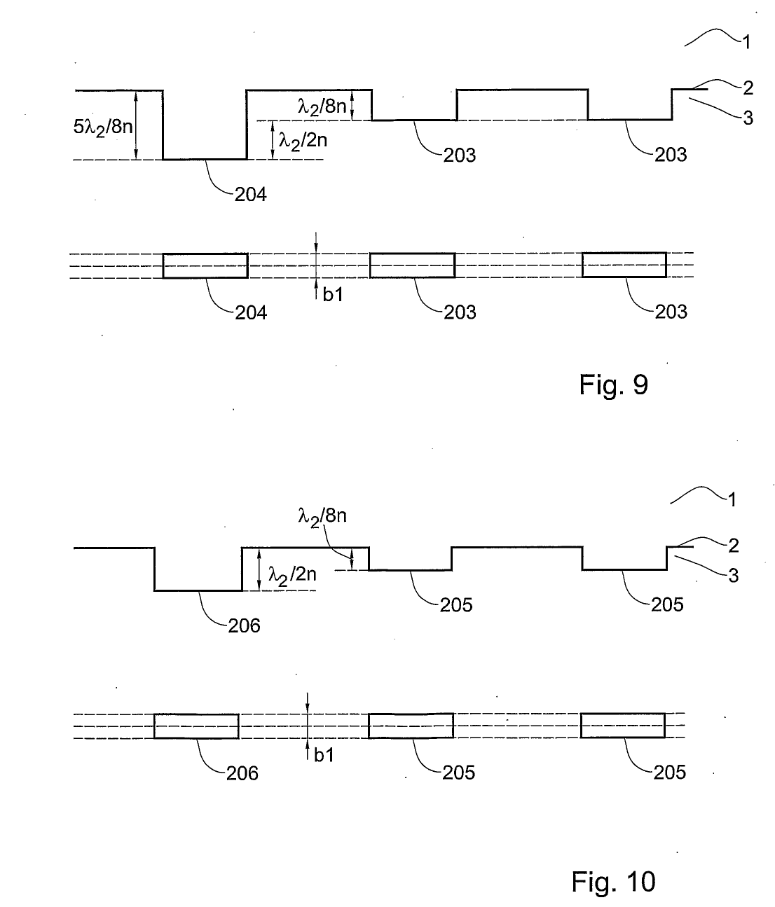

However, this depth λ₂/8n of the pit might result in a weak fluorescent signal of the medium from the pit region. Therefore, k×λ₂/2n (where k is an integer of 1 or more) is preferably added to the depth. A preferred example is 5λ₂/8n. This is illustrated in FIGS. 8 to 10. FIG. 8 shows the reference layer configuration generally similar to that of FIG. 5, namely utilizing pits 201 and 202 of substantially the same depths and different widths, but where the pit depth is 5λ₂/8n (instead of 3λ₂/4n in FIG. 5). FIGS. 9 and 10 show the configurations generally similar to FIGS. 6 and 7, respectively, where the reference layer 2 has pits 203 and 204 of different (optical) depths and substantially the same widths (FIG. 9) and pits 205 and 206 of different depths and substantially the same widths (FIG. 10), but differing from the examples in FIGS. 6 and 7 in that the depth of pit 204 is 5λ₂/8n and the depth of 206 is λ₂/2n and depth of pit 203, 205 is λ₂/8n.

In order to efficiently pick up both the tracking error signal and a read signal (fluorescent response), from the pattern formed in the reference layer 2, the depth of the pit is preferably λ₂/6n. λ₂ is the wavelength of the reference beam L₂, and n is the refractive index at the wavelength λ₂ of the material interfacing with the reference layer 2 at the incident light side.

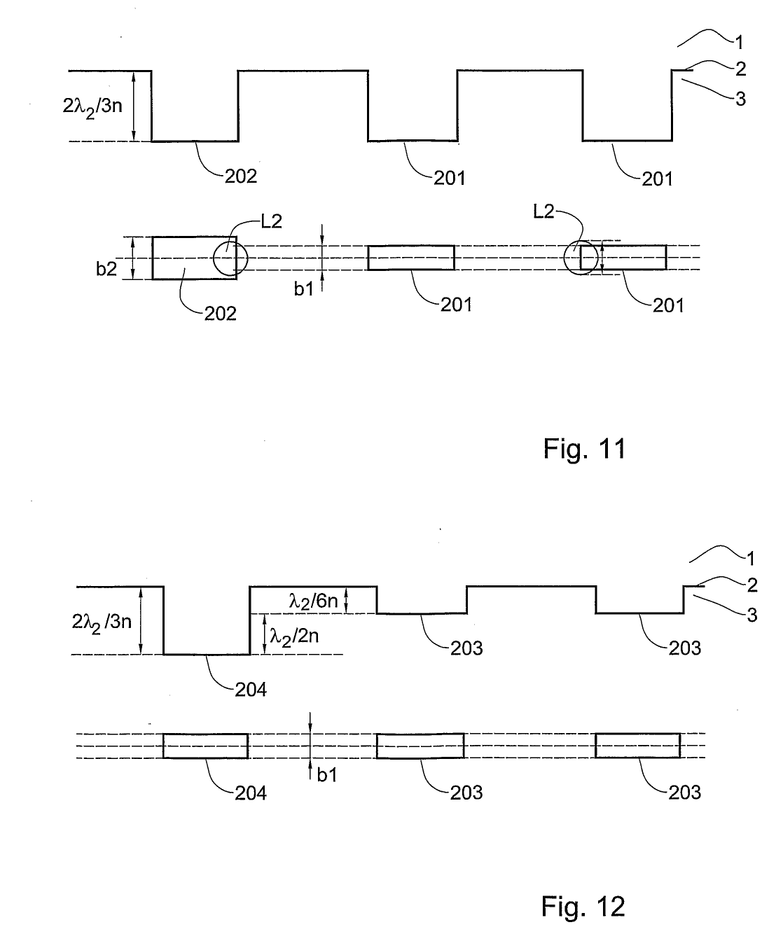

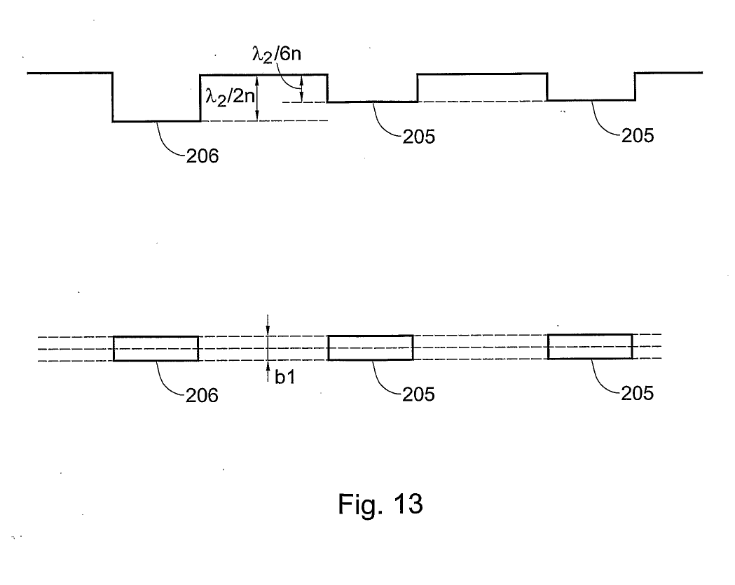

However, this depth λ₂/6n might result in a weak fluorescent signal from the pit region of the medium. Therefore, k×λ₂/2n (where k is an integer of 1 or more) is preferably added to the depth. A preferred example is 2λ₂/3n. This is illustrated in a self explanatory manner in FIGS. 11 to 13.

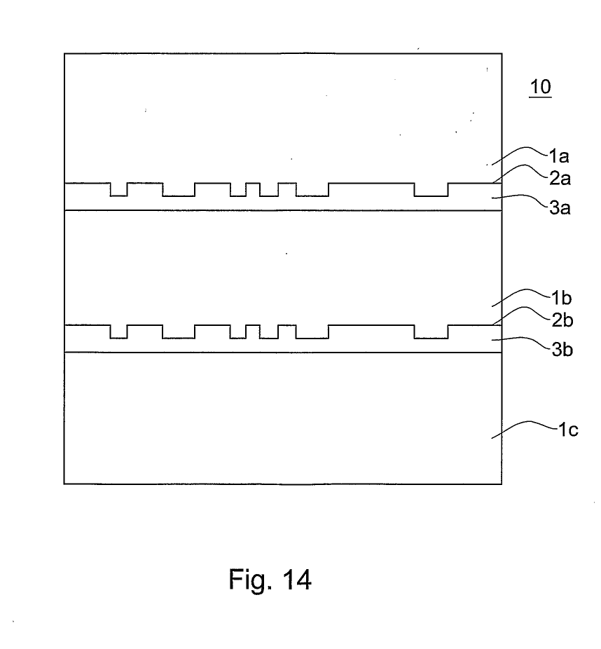

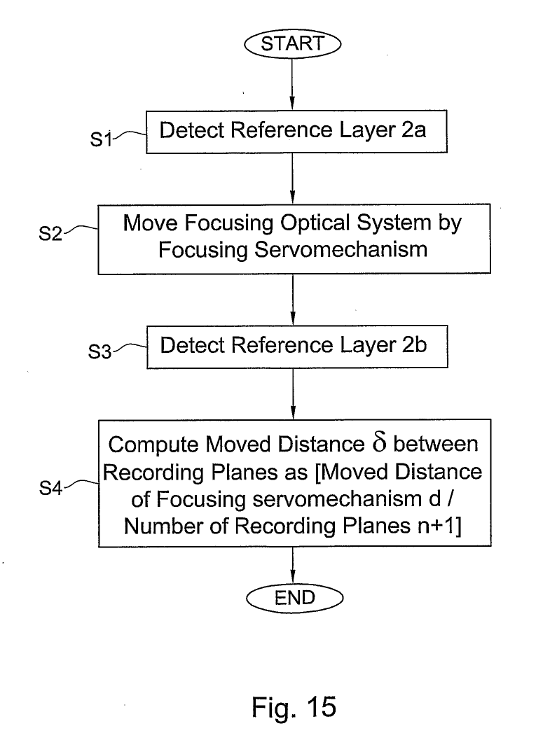

As described above with reference to FIGS. 1A-1B and 2, the optical data carrier includes an intermediate recording layer 1 sandwiched between two reference layers 2 arranged in the vertical direction. With this configuration, the thickness of the recording layer 1 can be measured through operation of calibration and, based on the result, the number of recording planes formed in one recording layer 1 and the interval therebetween can be controlled. This is described with reference to FIGS. 14 and 15.

As shown in the example of FIG. 14, an optical data carrier 10 includes two reference layers 2a and 2b, and a recording layer 1b sandwiched therebetween. FIG. 15 shows a flowchart of a method of detecting the reference layer 2a. A reference beam L₂ is irradiated, and using a servomechanism (controller 30 in FIGS. 1A and 1B), the reference beam L₂ is focused on a reference layer 2a (step S1).

Subsequently, the recording/reproducing beam L₁ is irradiated, and the focus position thereof is controlled to coincide with the reference layer 2, using a servomechanism by the controller 30, that is, by monitoring the intensity of the fluorescent light to control the focusing optical system 24. Then, by moving the piezo mirror (28 in FIGS. 1A and 1B) and detecting a change in fluorescent light intensity, focusing of the recording/reproducing beam L₁ on the same reference track as the reference beam L₂ is controlled. Next, while fixing the piezo mirror 28, the focusing optical system 24 is controlled to move the focus position of the recording/reproducing beam L₁ upward. The focus position of the recording/reproducing beam L₁ is moved up to the inflexion point of the fluorescent light intensity of the beam L₁ (step S2). In this case, since the position of the piezo mirror 28 is kept fixed while the focus position of the beam L₁ is moved, the optical axis of propagation of the recording/reproducing beam L₁ is kept such that it coincides with the optical axis of propagation of the reference beam L₂. The inflexion point of fluorescent intensity is obtained when the focus position of the beam L₁ coincides with the other reference layer 2b (step S3).

A distance d of the movement of focus position of the beam L₁ (a distance between interfaces) is then computed. Based on this moved distance d, when n recording planes are formed in one recording layer, a moved distance 8 between adjacent recording planes can be computed as d/(n+1) (step S4).

A calibration of the focusing servomechanism is performed as described above. After the completion of this calibration, recording by the recording/reproducing beam L₁ can be started. On recording, by the operation of the servomechanism, the focus position of the reference beam L₂ is kept on a reference track on the reference layer 2, and the piezo mirror 28 is kept in a fixed state. Accordingly, the optical axis of the recording/reproducing beam L₁ is kept in a state that it coincides with the optical axis of the reference beam L₂. In this situation, by raising the intensity of the recording/reproducing beam L₁, information recording may be conducted.

Let us suppose that a data carrier has only one reference layer 2, but there exists an interface or a surface with different fluorescence property, and the interface or the surface is parallel to the reference layer 2. In this case, by performing the same operation as described above using the interface or the surface and the reference layer 2, the moved distance between the recording planes may be calibrated. By performing a calibration using this method, effects caused by individual differences between recording media, change in characteristics with time, differences in the recording/reproducing devices or the like may be restrained, thereby allowing recording/reproducing with high accuracy.

It should be noted that as to the distance d between the interfaces and the number N of the recording planes, a value provided by a standard is used as it is i.e. as specified by the standard. Alternatively, when various types of standards exist, specific information about the standard to be used may be recorded in the reference layer 2 of the data carrier, and this information may then be read from the reference layer when the medium is used to set the desired distances between the recorded layers in the medium and between the recorded layers and the corresponding layer(s).

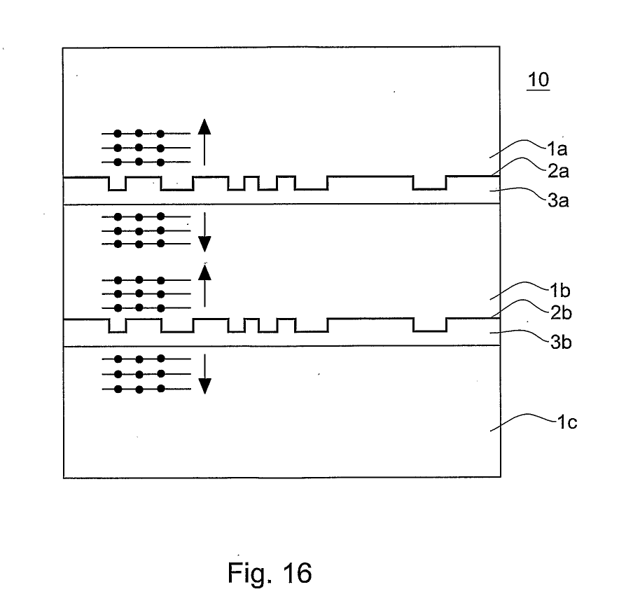

Reference is made to FIG. 16, describing a procedure of forming recording planes in two recording layers located above and below a reference layer. This procedure is aimed at suppressing as much as possible the effects of spherical aberration of the recording/reproducing beam L₁. For example, in a reference layer 2a interposed between two recording layers 1a, 1b, calibration of the recording/reproducing beam L₁ and the reference beam L₂ is executed (starting with the two beams coordinated to the same layer/track). Thereafter, while the reference beam L₂ is focused on the reference layer 2a, the focusing optical system (24 in FIGS. 1A and 1B) is driven to vary the focused position of the recording/reproducing beam L₁ in the vertical direction crossing the reference layer 2a. In accordance with this procedure, in comparison with recording only to the recording layer located on a single side of the reference layer, the moved distance of the focused position of the recording/reproducing beam L₁ from the reference layer is made shorter. This is effective to suppress the introduction of spherical aberration into the recording/reproducing beam L₁ as low as possible. In other words, if for example the thickness of the intermediate recording layer 1b is 0.4 mm and the only layer 2b is used as the reference layer, a distance that recording/reproducing beam L₁ has to move from the reference layer 2b to locate the recording/reproducing beam spot within the intermediate recording layer is 0.4 mm, but if both the reference layer 2a and the reference layer 2b are used, the recording/reproducing beam L₁ is necessary to move only 0.2 mm from any of the reference layer. Also on reproducing, the above method may be employed to execute calibration of the recording/reproducing beam L₁ and the reference beam L₂. As a result, reading can be executed accurately while accurately focusing the reproducing beam L₁ on the recording plane.

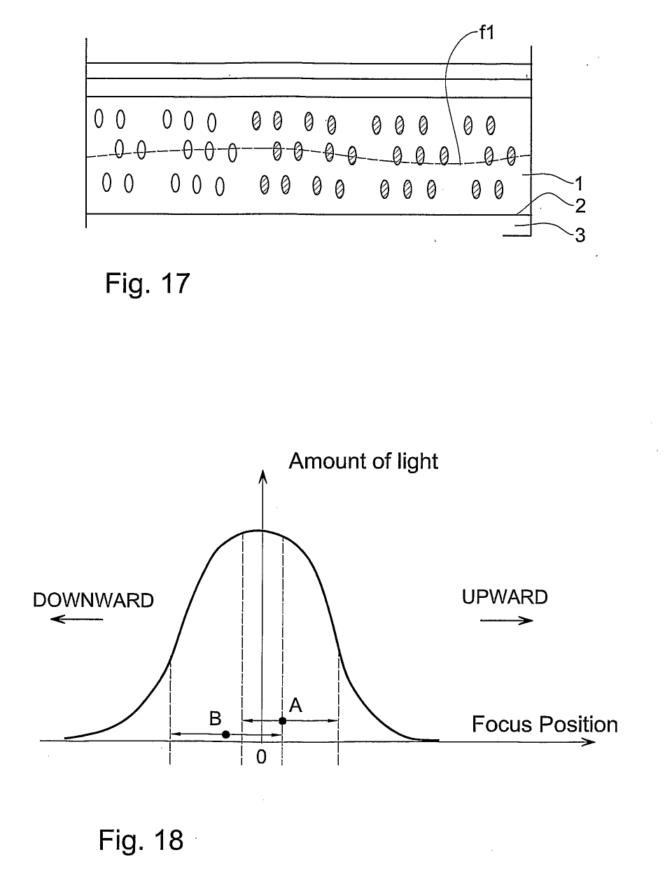

Preferably, on data reproducing from the data carrier 10, the focusing optical system 14 (FIGS. 1A and 1B) is driven at a certain cycle (wobbling frequency f₁) while setting as a reference a constant relative focused position of the reproducing beam relative to the focused position of the reference beam L₂ on the reference track of the reference layer, to vary the focused position of the reference beam L₂ in the data carrier thickness direction. In other words, in this specific example, the recording process proceeds while scanning within a plane (ideally, the so-called “flat spiral” movement f the recording beam). Thus, as a result, as shown in FIG. 17, the reference focused position of the recording/reproducing beam L₁ during reading is wobbled in the data carrier thickness direction (wobbling in the optical axis direction). In such a scheme, the intensity of the reproduced (read) signal varies at the detector (16 in FIGS. 1A and 1B) in accordance with the variation cycle of the focused position. Accordingly, even if only one detector 16 for data reading is provided as in FIGS. 1A and 1B, an optimal focused position of the recording/reproducing beam L₁ can be specified. Various detection methods are described in WO 03/070689 and WO2005/015552 assigned to the assignee of the present application. Thus, the focused position can be controlled precisely on the recording plane as specifically described with reference to FIG. 17.

FIG. 18 shows a relation between the focused position of the recording/reproducing beam L₁ (when the position of the recording plane to be read is determined as zero position) and the amount of fluorescence received at the detector (16 in FIGS. 1A and 1B). When the focused position is precisely coincident with the recording plane while wobbling about the position in the focus direction, the amount of light received at the detector 16 on vibrating upward is almost equal to that on vibrating downward. On the other hand, as shown by A in FIG. 18, when the focus position is shifted upward from the correct position, the reduction in the amount of light on vibrating upward becomes larger than that on vibrating downward in wobbling in the focus direction. To the contrary, as shown by B in FIG. 18, when the focus position is shifted downward, the reduction in the amount of light on moving upward becomes smaller than that on moving downward in wobbling in the focus direction. This fact indicates whether the focus position is shifted upward or downward. The focus position can be controlled such that the reduction in the amount of light on moving upward coincides with that on moving downward. In this case, even a single detector can control focusing of the recording/reproducing beam L₁. By performing wobbling while setting as a reference a position relatively apart from the reference track of the reference layer 2, a stable tracking may become easy, even if a deformation of the data carrier or the like occurs.

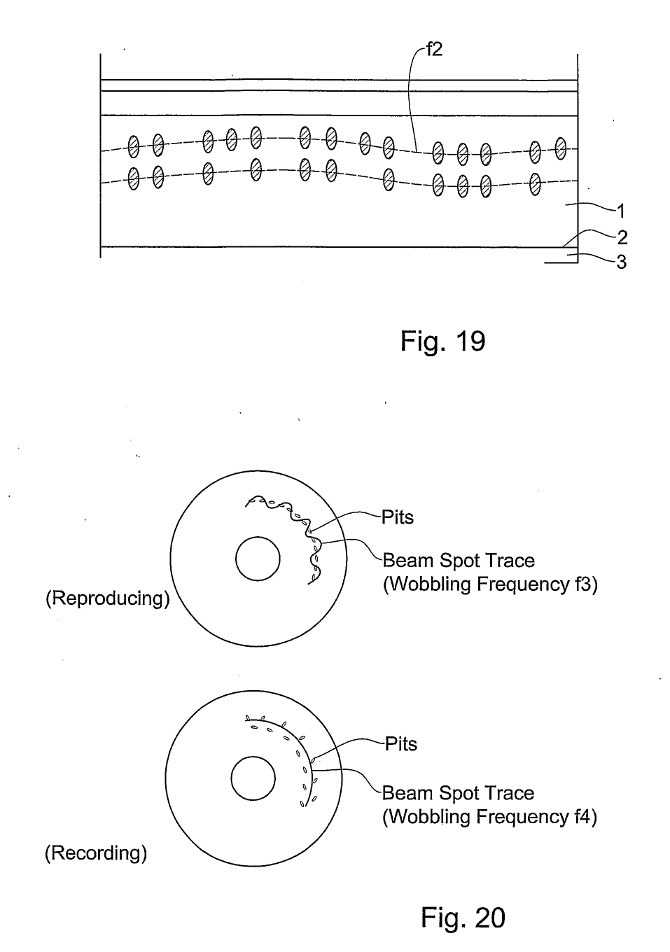

Reference is made to FIG. 19, showing that not on data reproducing from the data carrier but on recording thereto, the focused position of the recording/reproducing beam L₁ may be wobbled in the optical axis direction at a wobbling frequency f₂, for example, while reading proceeds in the data plane. It should, however, be noted that as the layers practically have not-precise planarity, because of the manufacturing process, the plane scanning is adjusted accordingly. In this case, focusing control can be executed on reproducing not to follow the wobbling frequency f₂ with the same effect as above. The similar concept is applicable to tracking control. In tracking control, as shown in FIG. 20, on reproducing or on recording, wobbling can be executed (at wobbling frequencies f₃, f₄). In this case, to distinguish between the focusing control and the tracking control, the wobbling frequency in the focusing direction (the first frequency: f₁, f₂) and the wobbling frequency or the phase in the tracking direction (the second frequency: f₃, f₄) are made different from each other. Then, from the reproduced signal, these two frequency components are separated and extracted for the above described processing. By performing the above-described calibration, roughly aligning the focus position of the recording/reproducing beam L₁ to one of the recording planes based on the calibration result, and conducting wobbling on the basis of the rough-aligned position, a sensitive alignment of the recording/reproducing beam L₁ can be performed.

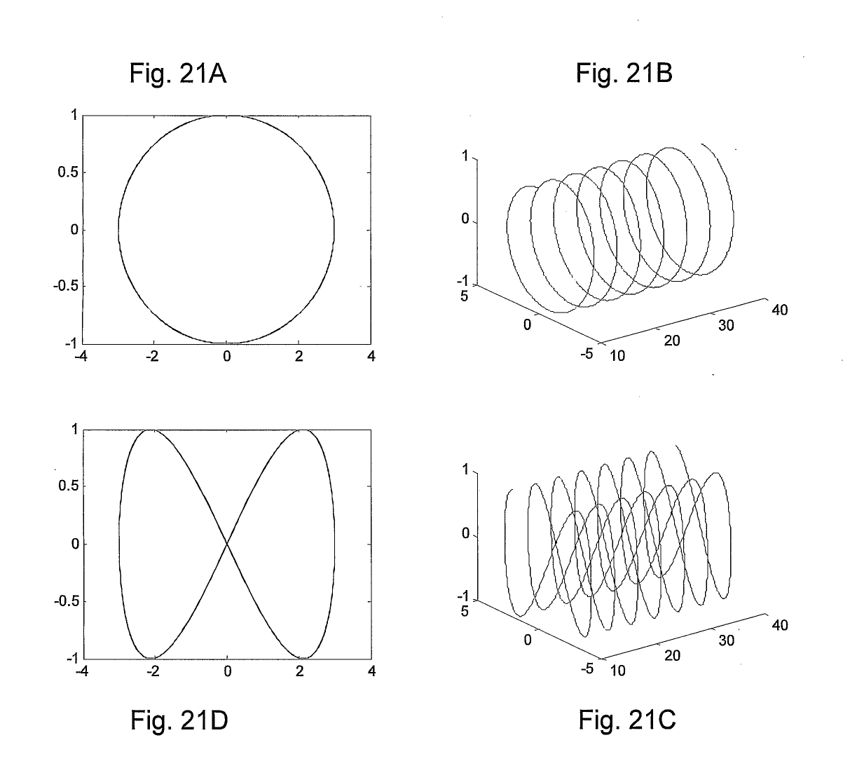

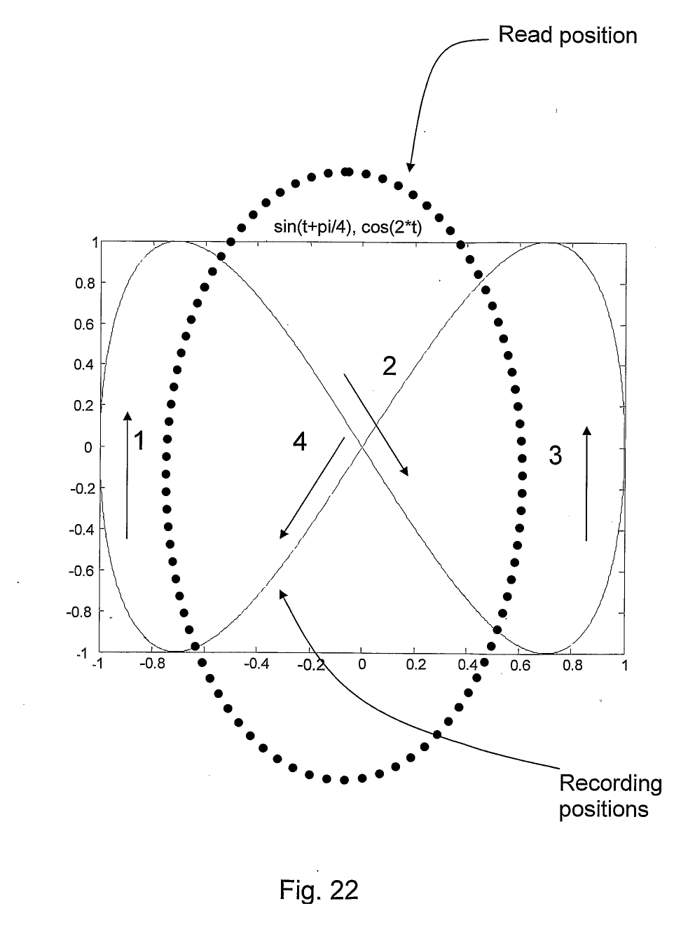

Reference is made to FIGS. 21A-21D and FIG. 22 describing possible structures of the recorded track (reference layers are not shown here). FIGS. 21A-21D show an embodiment in which the frequency of the modulation of the spot position in the radial direction is the same as in the axial direction. As shown in FIGS. 21A and 21B, the recorded track forms a small cycle around a nominal position that is of helical form where a ratio between the amplitudes of the modulation in the radial and axial directions determines the ellipticity of the helix. A phase difference of π/2 between the modulations is used. The focus error signal (FES) and tracking error signal (TES) may be derived by a first step phase locking on the amplitude modulation of the signal when being approximately on track and a second step of deriving the error signals using for example output of a window integrator (with a window size T) of the form:

$${err}_{i} ( t ) = {\int }_{t - T}^{t} {m}_{i} \cdot I ( t ) d t$$

where the index i refers to the specific error signal (FES or TES), mᵢ is the derived phase locked internal signal, and I(t) is the signal from the medium.

The beam position approximately on track can be achieved by using the controlled distance from the reference layer, by a slow motion in either one of the radial and axial directions and by the fact that a spiral shape of a track helps to be approximately on track in a ‘once around’ fashion.

As noted above, using two frequencies is also a method for separating between the signal components for the FES and TES. FIGS. 21C and 21D show another embodiment of the recorded pattern. In this embodiment the form of the track is more complex. Where both the phase difference is controlled and the frequency difference is used, the error signals can be derived. In this specific embodiment, the modulation frequencies and phases are chosen to be (sin(t+pi/4), cos(2*t)), the resulting form of the track is a complex helix with a cross over in the center of the nominal track. FIG. 21D shows a 3D plot of an exaggeration of the track to qualitatively show its shape. FIG. 21C illustrates a projection of the track relative to the nominal track position. As shown more specifically in FIG. 22, a Lissagou pattern is formed in this projection by the nominal recorded track. The dotted ellipse shows the relative position of the read beam in this projection. Arrows 1-4 schematically show that once there is a phase lock to the track signal, the motion relative to the nominal track can be derived and therefore the read beam is not required to modulate. As the required motion of the read beam focus relative to the nominal track is known, the correction to the correct position can be performed.

1. An optical data carrier, comprising:
at least one recording layer composed of a material having a non-linear response to interaction with an optical beam variable on occurrence of multi-photon absorption resulted from said interaction, said recording layer having a thickness for forming a plurality of recording planes therein; and
at least one reference layer having a reflecting surface interfacing with the recording layer, said reference layer having a predetermined pattern.

2. The optical data carrier according to claim 1, wherein said pattern in the reference layer comprises a surface relief made in said reflecting surface and configured for detecting effects of focusing of a recording/reproducing beam and focusing of a reference beam independent of said recording/reproducing beam.

3. The optical data carrier according to claim 1, wherein said pattern in the reference layer is in the form of an array of spaced-apart pits.

4. The optical data carrier according to claim 3, wherein a depth of said pit is selected to maximizes a servo signal used for tracking.

5. The optical data carrier according to claim 3,
wherein said array of pits includes the pits configured with a substantially rectangular cross-sectional shape and having a depth optically corresponding to a depth of (λ2/4n+k×λ2/2n), where λ2 is a wavelength of the reference beam, n is a refractive index at the wavelength λ2 of a material interfacing with said reference layer upstream thereof in a direction of propagation of the optical beam towards the reference layer, and k is an integer of 1 or more.

6. The optical data carrier according to claim 3,
wherein said array of pits includes the pits configured with a substantially rectangular cross-sectional shape and having a depth optically corresponding to a depth of (λ2/8n+k×λ2/2n), where λ2 is a wavelength of the reference beam, n is a refractive index at the wavelength λ2 of a material interfacing with said reference layer upstream thereof in a direction of propagation of the optical beam towards the reference layer, and k is an integer of 1 or more.

7. The optical data carrier according to claim 3, wherein said array of pits includes
at least one first pit having a width selected to be smaller than a beam spot cross-sectional dimension of said reference beam, and
at least one second pit having a width selected to be equal to or larger than said beam spot cross-sectional dimension of said reference beam.

8. The optical data carrier according to claim 3, wherein a width b of said pit is selected to satisfy a condition that A/2<b<A, where A is a beam spot cross-sectional dimension of said reference beam.

9. The optical data carrier according to claim 3, wherein said pits include at least one first pit and at least one second pit, the second pit being larger in volume than said first pit.

10. The optical data carrier according to claim 9, wherein first and second pits are substantially of the same depth and of different widths.

11. The optical data carrier according to claim 9, wherein the first and second pits are of substantially the same width and different depths.

12. The optical data carrier according to claim 9, wherein said first pit has a depth selected such that reflections of the reference beam from the pit bottom and from the pit top cancel each other out by interference.

13. The optical recording medium according to claim 3, wherein said array of pits includes the pits of substantially the same depth and width defining the pit volume maximizing the non-linear response and the reflection of the reference beam.

14. The optical data carrier according to claim 10, wherein said first pit has a depth of λ₂/4n and said second pit has a depth larger than said first pit by k×λ₂/2n, where k is an integer of 1 or more, λ₂ is the wavelength of said reference beam, and n is the refractive index of a material interfacing with said reference layer upstream thereof in a direction of propagation of the optical beam towards the reference layer.

15. The optical data carrier according to claim 10, wherein said first pit is configured with a depth of λ₂/4n, and said second pit is configured with a depth of 3λ₂/4n, where λ₂ is the wavelength of the reference beam, and n is the refractive index of a material interfacing with said reference layer upstream thereof in a direction of propagation of the optical beam towards the reference layer.

16. The data carrier according to claim 1, wherein the recording layer is located between two reference layers.

17. The data carrier according to claim 1, wherein the reference layer is located between two recording layers.

18. The data carrier according to claim 32, wherein the non-recording layer is an air space.

19. The data carrier according to claim 16, wherein
said two reference layers formed on both surfaces of said recording layer are configured to form respective pre-formatted reflecting interfaces and enable detection of effects of independently focusing of a recording/reproducing beam and a reference beam on the patterned reflecting surface.

20. The optical data carrier according to claim 17, wherein
the reference layer formed between the recording layers is configured to form a pre-formatted reflecting interface to thereby enable to control at least one of data recording and reading processes by detecting effects of focusing of a recording/reproducing beam and a reference beam on said reflecting interface.

21. A method for recording/reproducing data in an optical data carrier, comprising at least one recording layer having a thickness for forming a plurality of recording planes therein and composed of a material having a non-linear optical response to an interaction with an optical beam variable on occurrence of multi-photon absorption resulted from said interaction at least one non-recording layer differing in its non-linear optical response from said recording layer, and at least one reference layer having a reflecting surface interfacing with the recording layer,
said method comprising multi-layered recording to or reproducing data from said recording layer, based on at least one of the following: detection of reflection of light from a pattern formed in the reference layer and detection of a fluorescent response from the data carrier.

22. A method according to claim 21, wherein the recording of data comprises controlling detection of the reflection of the reference beam.

23. A method according to claim 21, wherein the reproducing of the recorded data comprises controlling detection of the light response from the data carrier.

24. A method according to claim 21, wherein the reproducing of the recorded data comprises controlling detection of the reflection of the reference beam.

25. (canceled)

26. (canceled)

27. A method for recording data in an optical data carrier, which comprises at least one recording layer having a thickness for forming a plurality of recording planes therein and composed of a material having a non-linear response to interaction with an optical beam variable on occurrence of multi-photon absorption resulted from said interaction, at least one non-recording layer differing in its non-linear response from said recording layer, and at least one reference layer having a reflecting surface interfacing with the recording layer, the method comprising:
focusing both a reference beam and a recording/reproducing beam onto a reference track on the first reference layer;
while keeping a focus of the reference beam on the reference track on the first reference layer, and keeping the both beams coaxial to each other, moving a focus position of said recording/reproducing beam to focus said recording/reproducing beam on a second reference layer, being an interface or a surface where the non-linear response changes; and
measuring a distance between the first and second reference layers, to perform calibration of a focusing servomechanism.

28. (canceled)

29. A method for recording data in an optical data carrier, which comprises at least one recording layer having a thickness for forming a plurality of recording planes therein and composed of a material having a non-linear response to interaction with an optical beam variable on occurrence of multi-photon absorption resulted from said interaction, at least one non-recording layer differing in its non-linear response from said recording layer, and at least one reference layer having a reflecting surface interfacing with the recording layer, the method comprising:
focusing a reference beam on a certain reference layer and performing tracking control to keep the reference beam focused on a reference track on the reference layer;
focusing a recording/reproducing beam on the same reference layer as the reference beam; and
while keeping a focus of the reference beam on the reference track on the reference layer, moving a focus position of said recording/reproducing beam to record or reproduce information.

30. A reading method for an optical data carrier, the method comprising:
reading a reproduced signal while vibrating a focus position of a reproducing beam at a first frequency in the focus direction relative to a recording pit recorded in a recording layer for multi-layered recording; and
performing focusing control of said reproducing beam relative to said recording pit based on a relation between a variation in intensity of said reproduced signal and a direction of movement of said focus position.

31. A method for data recording in an optical data carrier, comprising vibrating a focus position of a recording beam relative to a recording layer for multi-layered recording at a first frequency in the focus direction to form a recorded mark in the recording layer.

32. The optical data carrier according to claim 1, comprising at least one non-recording layer differing in its non-linear optical response from said recording layer.

33. The optical data carrier according to claim 32, wherein said at least one non-recording layer is formed on at least one of upper and lower surfaces of the recording layer.
